(19) United States
(12) Patent Application Publication
(10) Pub. No.: US 2025/0270049 A1
(43) Pub. Date: Aug. 28, 2025

(54) CONVEYOR DEVICE

(71) Applicant: SOMIC VERPACKUNGSMASCHINEN GMBH & CO. KG, Amerang (DE)

(72) Inventors: Classen Egbert, Schonstett (DE); Maximilian Koenig, Schleching (DE)

(21) Appl. No.: 19/187,673

(22) Filed: Apr. 23, 2025

(30) Foreign Application Priority Data
Feb. 27, 2024 (EP) 24159964.6

(51) Int. Cl. B65G 21/20

(52) U.S. Cl. CPC B65G 21/2036

(57) ABSTRACT

Disclosed is a conveyor device having a conveyor belt with a support surface and a rear surface facing away from the support surface, at least one flow path which connects the support surface to the rear surface, a suction box which is arranged on the rear surface of the conveyor belt and is fluidically connected to one end of the flow path which opens into the rear surface, and at least one valve element which is adjustable between a passage position and a blocking position, where the valve element interrupts or closes the at least one flow path in its blocking position and creates or releases it in its passage position, wherein the valve element protrudes at least partially from the support surface of the conveyor belt in the blocking position.

### CROSS REFERENCE TO RELATED APPLICATION

This application claims priority to European Patent Application No. 24159964.6, filed in Europe on Feb. 27, 2024, the entire contents of which are hereby incorporated herein by this reference.

### DESCRIPTION

The invention relates to a conveying device comprising a conveyor belt with a support surface and a rear surface facing away from the support surface, and at least one flow path connecting the support surface to the rear surface, a suction box which is arranged on the rear surface of the conveyor belt and is fluidically connected to one end of the flow path which opens into the rear surface, and at least one valve element which is adjustable between a passage position and a blocking position, wherein the valve element interrupts or closes the at least one flow path in its blocking position and creates or releases it in its passage position.

In practice, such conveyor devices are equipped with a conveyor belt to transport the conveyed material placed on it. In general, an additional retaining force is applied to the conveyed material so that its sliding or falling off the conveyor belt can be prevented, although the conveyed material can also be transported merely by being placed on the conveyor belt.

It is known to achieve the required retaining force by subjecting the conveyed material to a vacuum. For this purpose, a suction box is typically arranged beneath the conveyor belt, which generates a vacuum via a vacuum blower and corresponding openings in the conveyor belt, thereby retaining the conveyed material on the conveyor belt.

Conveyor belts designed in this manner must generally be provided with a large number of openings in order to ensure that a plurality of them continuously draw in the conveyed material and retain it on the conveyor belt.

However, it is disadvantageous that, during operation, openings not covered by conveyed material draw in false air, i.e. air that cannot be used to generate a retaining force. The vacuum blower must therefore be designed with a correspondingly high output and consequently requires more energy than would be necessary to retain the conveyed material. In addition, noise and heat emissions are generated.

To remedy this, EP 2 492 222 A1 proposed creating a space beneath the conveyor belt by elevating its support and designing the conveyor belt to be elastic. As a result, when a vacuum is applied, the suction line is sealed if no conveyed material is present on the openings adjacent to the suction line, and a retaining force is exerted on the conveyed material as soon as it is placed on the conveyor belt.

In the process, the elastically designed portion of the conveyor belt loses at least part of its elasticity over time due to stress caused by ageing, environmental influences or the like. This results in a reduced restoring capability of the elastically designed portion of the conveyor belt and, consequently, a less form-fitting seal of the suction line. This, in turn, leads to increased leakage and a greater demand for vacuum. In addition, increased noise emissions are generated.

It is therefore an object of the invention to provide a more robust conveyor device. This object is achieved, according to the invention, by a conveyor device of the type initially mentioned, in which the valve element, in its blocking position, protrudes at least partially from the support surface of the conveyor belt.

The transition of the valve element from the passage position to the blocking position and back occurs due to mechanical interaction, which utilizes the protrusion of the valve element. An example of this is the placement of conveyed material onto the valve element protruding from the support surface, which is shifted into the passage position by the weight of the conveyed material. This approach relies solely on mechanical interaction and does not depend on material-inherent properties that may change over time. This results in a more reliable sealing of the flow path, thereby reducing leakage and noise emissions over the service life of the conveyor belt.

A level and thus secure placement of the conveyed material can be achieved in that, in a further development, the valve element in the passage position is arranged substantially flush with the support surface or recessed therein.

In a further development of the invention, the conveyor device may additionally comprise a vacuum unit associated with the suction box. A vacuum unit of this type consumes less energy compared to the side channel blowers commonly used. Therefore, it is more sustainable and cost-effective. Moreover, the system and the conveyor device as a whole require less space, as the vacuum unit generally has smaller dimensions.

Advantageously, the valve element may be assisted in displacing into the blocking position, thereby ensuring a secure and reliable closure of the suction line or flow path, for instance, upon premature removal of the conveyed material from the conveyor belt or when no conveyed material is present. This prevents the suction line or flow path from acting as a blind suction device and drawing in false air, which would disproportionately increase energy consumption. In a further development of the invention, it may be contemplated that the at least one valve element is biased towards the blocking position, for example, by being preloaded. Applying a preload to the valve element can serve as a cost-effective means of providing this assistance. By way of example, a spring may be considered, which is arranged beneath the valve element or at one end of the flow path.

A further possibility for achieving this assistance can be that in a development of the invention, the conveyor device can comprise at least one pair of magnets, wherein one magnet from the pair of magnets can be arranged in the conveyor belt and the other magnet from the pair of magnets can be arranged in the valve element, wherein at least one magnet from the pair of magnets can be an active magnet, and wherein the magnets from the pair of magnets can be arranged and designed and intended such that they can pull the valve element from the passage position towards the blocking position by means of the attractive force or the repulsive force that they exert on one another.

In such a configuration, at least one magnet from the pair of magnets should be an active magnet, such as a permanent magnet or an electromagnet. In contrast to passive magnets, active magnets generate a magnetic field even if they are not influenced by an external magnetic field. A rare earth magnet, preferably a samarium-cobalt magnet or a neodymium-samarium-cobalt magnet, can be used as a permanent magnet.

Although using two active magnets-particularly two permanent magnets-offers advantages in terms of magnetic force strength, it is conceivable, especially for cost reduction of the magnetic fastening device, that one of the magnets from the pair is formed by a passive magnet, such as an element composed at least partially of a ferromagnetic or ferrimagnetic material, which becomes magnetized by the other magnet. Passive magnets only emit a magnetic field when they are magnetized by an active magnet.

Another way of achieving this assistance may be that, in a further development of the invention, the conveying device may comprise at least one pressurized gas nozzle, which may be designed and intended to be able to move the at least one valve element from the passage position to the blocking position. This nozzle can be arranged beneath the valve element or on the rear surface to, for example, push a slide valve element out of the conveyor belt, or above the support surface to move a rocker-type valve element back into the blocking position.

It is generally desirable for the conveyor device according to the invention to allow for rapid and efficient repair or replacement of defective components. It may therefore be considered, in a further development of the invention, that the valve element forms part of a valve insert, which is formed in a through-hole of the conveyor belt. This design allows for the replacement of individual valve inserts requiring repair without necessitating the replacement of the entire conveyor device or the entire conveyor belt. It may be particularly advantageous for the flow path to be formed within the valve insert.

It is both economically and environmentally prudent to minimize the air flow requirements of the suction box and a vacuum blower connected to it or a pump connected to it to the maximum extent possible. One possibility for this could be, in a further development of the invention, to allow an end of the flow path closest to the support surface to open into a recess which can be formed in the support surface. This could be both the actual support surface and a surface section that is only temporarily part of the support surface, for example an end face of a slide valve element. Since the recess provides a larger cross-sectional area than the mere opening of the flow path, the vacuum generated by the suction box or the vacuum blower connected to it or the pump connected to it upon a larger surface area and this results in a correspondingly greater retaining force on the conveyed material. Accordingly, a lower vacuum can be used to generate the same retaining force. This involves a reduction in consumed energy, which is overall more sustainable and cost-saving. Last but not least, noise emissions are also reduced. Furthermore, the valve element may be supported within this recess, allowing for an arrangement in the passage position that is substantially flush with or recessed into the support surface.

A structurally simple and thus (cost-) efficient means of enabling the valve element to open and close may involve providing an axle element associated with the valve element, around which the valve element is pivotable. This axle element can divide the valve element into two sections, with one section designed and intended to seal the flow path.

According to a first alternative, the axle element can be formed in one piece with the valve element. Furthermore, the pivoting of the valve element may be realized by a bearing arranged within the conveyor belt. An integral design of the axle element with the valve element offers the advantage of reducing the number of components, thereby simplifying assembly and maintenance, and resulting in lower manufacturing costs. Additionally, this design can decrease friction and wear between the axle element and the valve element, enhancing the valve's lifespan and reliability.

In general, a critical point with axle elements is how well the guidance and centering, and ultimately the pivoting, works. The better this is achieved, the smaller the clearance between the components will generally be and the sealing will increase. As a further alternative, the axle element of the conveying device can therefore also comprise an elongated element which can be arranged in a through-bore in the valve element. In addition, the problem of a plastic/plastic pairing can be avoided if the axle element is made of metal, and the problem that arises when the friction cannot be calculated accurately enough due to tolerances in directly mounted components can also be avoided.

Furthermore, the valve element may have a stop surface which may be designed and intended to cooperate with a counter-stop surface, wherein the stop surface and the counter-stop surface may be designed and intended in cooperation to limit the insertion movement of the portion which is not designed and intended to cover the flow path into the recess in the support surface. This avoids milling the recess in two levels and allows the recess to be milled in one step, which eliminates the need for laborious and therefore costly re-clamping during milling.

An even more effective sealing of the suction channel or flow path can be achieved by arranging a sealing lip on the side of the valve element facing the flow path, which is designed and intended to cover the flow path. This design not only enables higher surface pressure and reliable sealing performance despite potential tolerances but also facilitates wear compensation and prevents the ingress of contaminants.

For financial reasons and also for sustainability reasons, the amount of air required by the suction box or the connected vacuum blower or vacuum pump should be as low as possible. This can be achieved, for example, by the valve element having a cutout in the side facing the support surface, as well as at least one lateral cutout and/or at least one cutout in the side facing away from the support surface. The cutout facing the support surface causes an increase in the cross-sectional area and thus a correspondingly greater retaining force on the material being conveyed. If a sufficient retaining force is achieved with a given cross-sectional area of the recess, then further increasing this area can allow for a reduction in the air flow capacity required by the vacuum blower. The at least one lateral cutout and the at least one cutout in the side facing away from the support surface in turn ensure that the cutout in the side facing the support surface is evacuated.

Once a valve element has passed the deflection roller at the beginning of the conveyor belt (as viewed in the direction of travel and placement of the conveyed material), it should either already be in the blocking position or be brought into that position. A simple and efficient approach to achieve this is by utilizing gravity. For instance, one might contemplate positioning the center of gravity of the valve element within the section designed to seal the flow path. As the valve element traverses the deflection roller at the beginning of the conveyor belt, it ultimately swings into the blocking position. To avoid relying solely on gravity for returning the valve element to the blocking position—particularly when restarting the system after a disruption—it may be contemplated to position a stop extending across the conveyor belt at the end of the deflection section, which imparts an impulse to the valve element towards the blocking position.

As an alternative to using gravity, one could also consider using centrifugal force. One possible approach is to position the center of gravity of the valve element within the section designed and intended to protrude from the support surface of the conveyor belt. In this case, this section of the valve element is pushed radially outwards as it rotates around the deflection roller, so that it protrudes from the support surface of the conveyor belt, while the other section of the valve element closes the flow path. If the suction box becomes effective in a timely manner, it must be ensured that the flow path remains sealed.

According to a further alternative, consideration may even be given to shifting the centre of gravity between the two sections of the valve element. For this purpose, a cavity can be provided in the valve element, for example, in which a predetermined mass can be accommodated so that it can be displaced back and forth. This mass may, in particular, be formed by a liquid or by one or more solid bodies, such as one or more spheres

As an alternative to the previously described rocker, the valve element may, in a further development of the invention, be configured as a slide valve element that is displaceable between the passage position and the blocking position, in which it interrupts or establishes the flow path, and a section of the flow path may extend within the slide valve element, with one end of this section opening into a circumferential surface of the slide valve element, and the flow path may further comprise at least one additional section, one end of which, in the passage position of the slide valve element, opens into the one end of the aforementioned section of the flow path, while in the blocking position, it may be arranged offset relative to it. Slide valves are generally known for their high sealing capability and low flow resistance, as they are closed perpendicular to the flow direction.

In the blocking position, the slide valve element can be arranged recessed in the body of the conveyor belt relative to the rear surface of the conveyor belt, while in the passage position it can preferably be arranged essentially flush with the rear surface. This makes it easier for the slide valve element to move past the edges of the suction box, regardless of its position, because it does not protrude downwards.

The conveying device can be designed in such a way that it can further comprise a projection at the end of the slide valve element closest to the support surface with a stop surface and a counter-stop surface associated therewith, wherein the interaction of the stop surface and the counter-stop surface can limit an insertion movement of the slide valve element into the support surface. This design prevents the slide valve element from moving uncontrollably into the conveyor belt and thus impairing its function.

The conveyor device may further comprise a projection at the end of the slide valve element nearest to the rear surface, featuring a stop surface and an associated counter-stop surface, wherein the interaction between the stop surface and the counter-stop surface limits the insertion movement of the slide valve element into the rear surface. By limiting the retraction path of the slide valve element, its correct operation is ensured.

The recess may be formed within the slide valve element. Here too, as already described above, the recess reduces the required air flow rate of the suction box, while at the same time, if the slide valve element or the valve insert is damaged, the entire conveyor belt does not need to be replaced.

It may further be contemplated that the conveyor device includes a return roller with at least one protrusion, which is designed and intended to displace the at least one slide valve element from the passage position to the blocking position. The return roller can, for example, be a deflection roller of the conveyor belt or a separate roller of the conveyor belt. The return roller assists the valve element in displacing to the blocking position, thereby ensuring a secure and reliable closure of the suction line or flow path-particularly after the conveyed material has been removed from the conveyor belt. This has the advantage that the suction line or flow path does not operate as an open or inactive suction source, which would otherwise lead to unnecessary energy consumption.

A further simplification in the manufacture of the conveyor device according to the invention can be achieved by designing the slide valve element essentially as a cylinder in the longitudinal direction. A cylindrical shape of the slide valve element also makes its installation easier and is less prone to wear due to the lack of edges.

To prevent the slide valve element from being continuously drawn into the passage position by the suction force from the suction box, it can be held in the blocking position by a retaining mechanism—such as a locking device, preferably a ball detent mechanism—and only shifted into the passage position through the mechanical action of the material being conveyed. In addition or as an alternative to the retaining mechanism, the friction of the slide valve element in its guide can also be selected to be so high that the suction force of the suction box is able to pull the slide valve element into the passage position.

The invention will be explained in more detail below with reference to several exemplary embodiments in the accompanying drawings. It is represented:

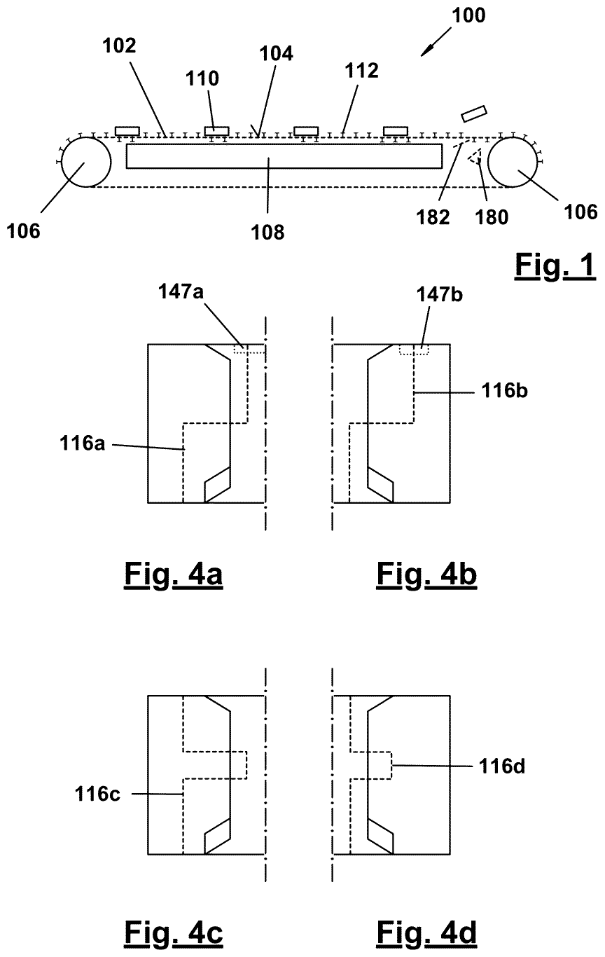

FIG. 1 a cross-sectional view of the conveyor device in a first embodiment; and

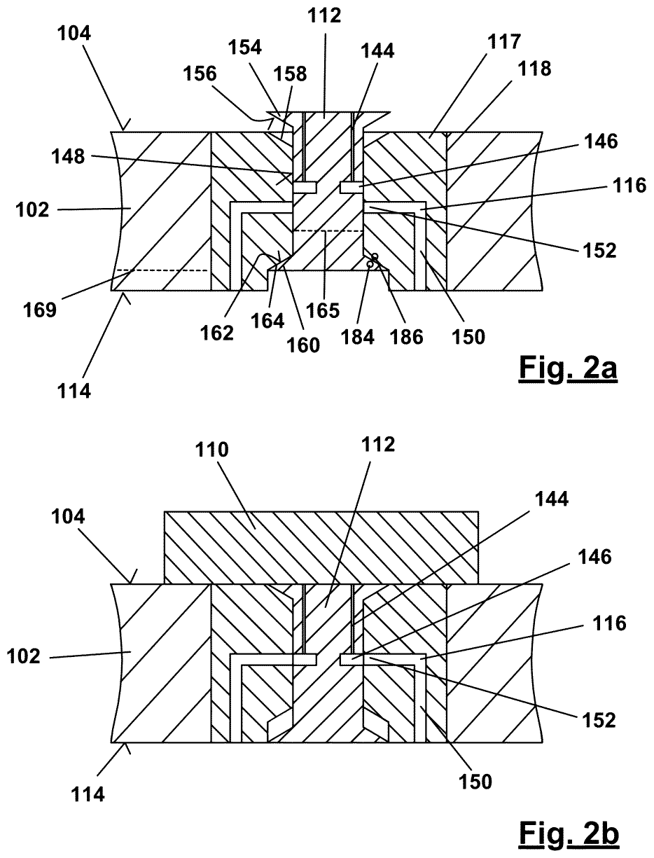

FIG. 2a a cross-sectional view of the first embodiment of the conveying device without any conveyed material in detail;

FIG. 2b a cross-sectional view of the first embodiment of the conveyor device, detailing the conveyed material resting on the belt.

FIG. 3 a cross-sectional view of a return roller;

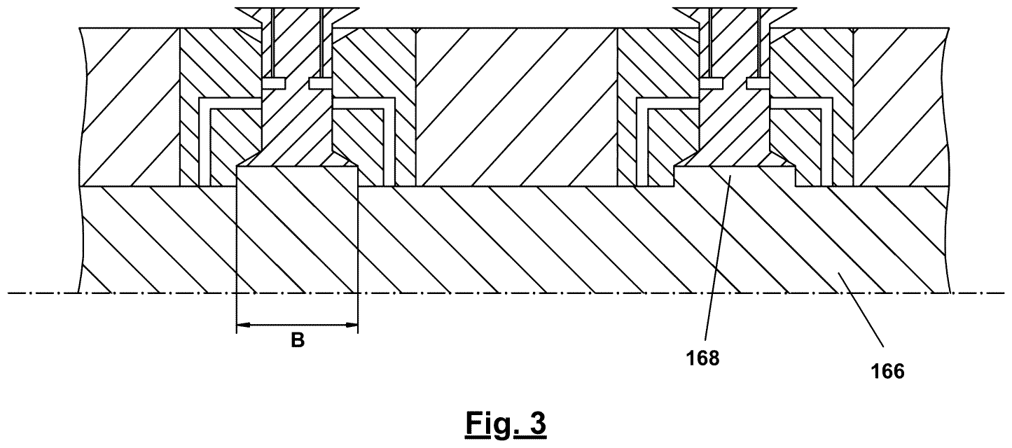

FIGS. 4a to 4d feature possible variants of the flow path;

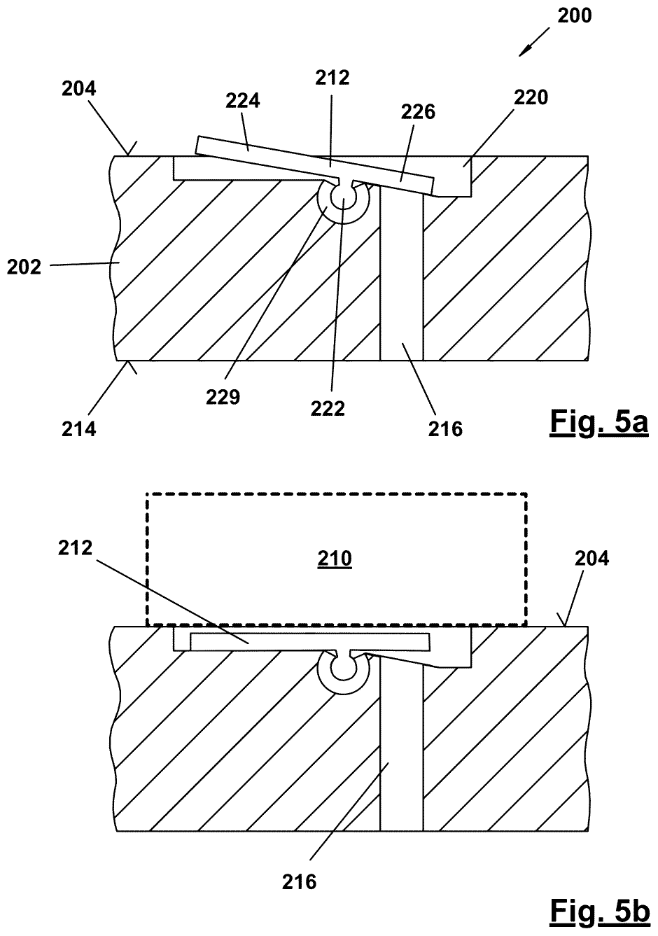

FIG. 5a a cross-sectional view of a second embodiment of the conveying device without any conveyed material in the passage position in detail;

FIG. 5b a cross-sectional view of the second embodiment of the conveying device without any conveyed material in the blocking position in detail;

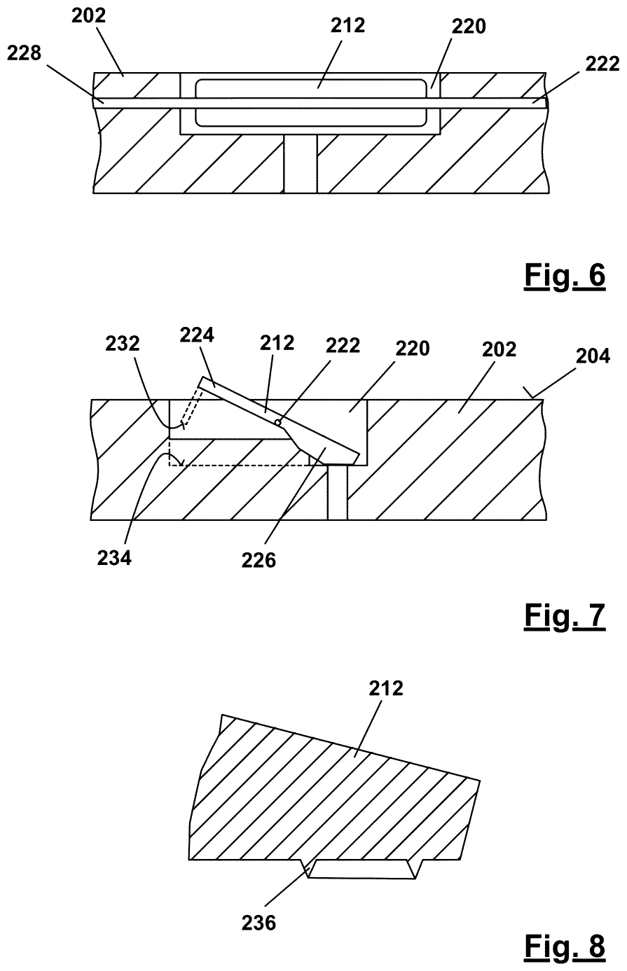

FIG. 6 a detailed cross-sectional view of an axle element of the second embodiment;

FIG. 7 is a detailed cross-sectional view of a valve element of a modification of the second embodiment;

FIG. 8 is a detailed cross-sectional view of a sealing lip of the valve element of the modification of the second embodiment;

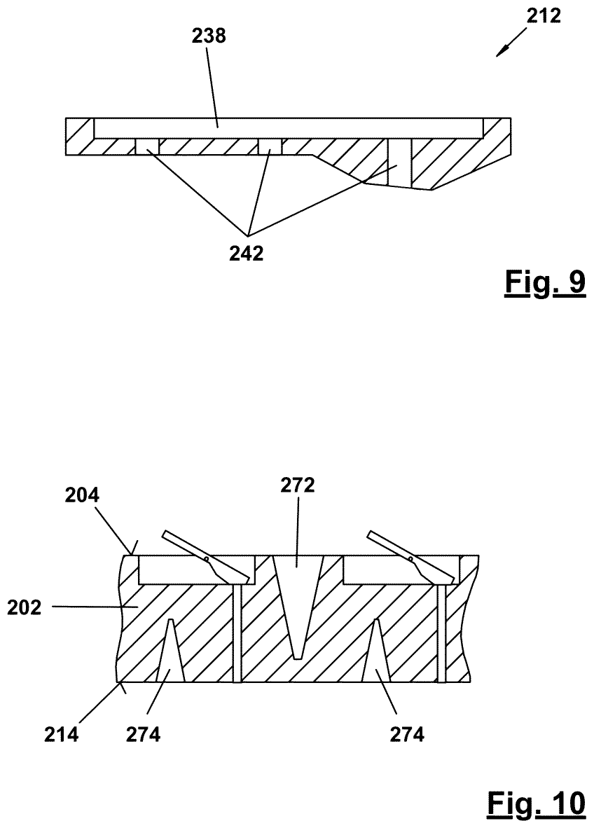

FIG. 9 a detailed cross-sectional view of a valve element of a further modification of the second embodiment with cutouts; and

FIG. 10 a cross-sectional view of a conveyor belt of the second embodiment.

In FIG. 1, a conveyor device according to the invention is generally designated by the reference numeral 100. The conveying device 100 comprises a conveyor belt 102 with a support surface 104, which is guided as a circulating belt conveyor over two deflection rollers 106, a suction box 108, which is arranged under the upper run of the conveyor belt 102, and conveyed material 110, which rests on the conveyor belt 102.

The conveyor belt 102 is guided during the conveying movement, in the upper guide between the two deflection rollers 106, partially over the suction box 108. The suction box 108 can also be designed as a vacuum chamber and is connected to a vacuum pump (not shown). Instead of the vacuum pump, a vacuum blower or a side channel compressor can also be used. When the valve element 112 is in the passage position, the suction box 108 is in fluid communication with the support surface 104 via a flow path 116 (see FIG. 2a), thereby exerting a suction force on the conveyed material 110 placed on the conveyor belt 102.

In the embodiment shown in FIG. 1, the valve elements 112 are configured as slide valve elements, preferably of cylindrical.

The slide valve elements 112 according to FIGS. 2a and 2b are arranged in the conveyor belt 102 such that in the blocking position (see FIG. 2a) they are arranged set back into the body of the conveyor belt 102 relative to a rear surface 114 of the conveyor belt 102, while in the passage position (see FIG. 2b) the slide valve elements 112 are preferably arranged substantially flush or slightly recessed with the rear surface 114. On the other hand, In the blocking position, the valve element 112 protrudes at least partially from the support surface 104 of the conveyor belt 102. In contrast, in the passage position, the slide valve element 112 is arranged either substantially flush with or slightly recessed into the support surface 104. The slide valve elements 112 can be displaced back and forth between these two positions.

FIG. 2a shows a section of the conveyor device 100 in its blocking position. In this position, no conveyed material 110 rests on the conveyor belt 102 and no or only a very small amount of false air can be drawn through the slide valve element 112 due to the offset of the two ends 146 and 152 of the sections 144, 150 of the flow path 116.

In the passage position of the slide valve element 112, the end 146 of the section 144 of the flow path 116, which runs in the slide valve element 112, opens into the end 152 of the section 150 of the flow path 116 and is in fluid communication therewith.

Furthermore, the slide valve element 112 can be part of a valve insert 117 formed in a passage opening 118 of the conveyor belt 102. The valve insert 117 may be designed as a cylindrical body featuring a central recess to accommodate the slide valve element 112 and it is installed into the conveyor belt 102 in such a way that its surface aligns flush with both the support surface 104 and the rear surface 114, ensuring a seamless and integrated configuration.

In this embodiment, the slide valve element 112 has a cylindrical body and circumferential projections 154 and 160 at each of its ends. The projections 154 and 160 can be positively engaged into corresponding recesses 158 and 164 of the valve insert 117 via matching stop surfaces 156 and 162, which serve as counter-stop surfaces. Advantageously, the slide valve element 112 is formed in two parts, as indicated in FIG. 2a by the dashed line 165, and joined together accordingly, so that installation of the slide valve element with projections 154, 160 in the conveyor belt 102 is possible.

The projection 154, which is arranged at the end of the slide valve element 112 closest to the support surface 104, limits the insertion movement of the slide valve element 112 into the support surface 104 by means of the interaction of the stop surface 156 with the counter-stop surface 158 associated therewith.

Likewise, the stop surface 162 of the projection 160 at the end of the slide valve element 112 closest to the rear surface 114, in interaction with the counter-stop surface 164 associated therewith, limits an insertion movement of the slide valve element 112 into the rear surface 114.

The end 146 of the section 144 of the flow path 116 can be formed circumferentially around a longitudinal axis of the, for example, cylindrical body of the slide valve element 112 as an annular groove in its surface. Furthermore, the end 146 of the flow path 116 can also be designed as a single indentation or as multiple indentations in the designated surface.

The slide valve element 112 transitions to the passage position when, for instance, conveyed material 110 is placed on the slide valve element 112. When the ends 146 and 152 of flow path 116 of the sections 144 and 150 are in fluid communication, the negative pressure generated by the suction box 108 applies a retaining force to the conveyed material 110 on the conveyor belt 102, securely retaining it during transport.

After the slide valve elements 112 have travelled the distance above the suction box 108, or when the conveyed material 110, which is located on one or more slide valve elements 112, is removed from the conveyor belt, the slide valve element(s) 112 previously occupied by the material 110 is/are returned to the blocking position of FIG. 2a.

Due to various factors, this may not occur automatically or may not be fully achieved. It can therefore be considered to arrange the deflection roller 106 arranged downstream of the suction box 108 in the conveying direction according to FIG. 3 as a return roller 166 with at least one protrusion 168 of width B. The width B is preferably equal to or less than the diameter of the slide valve element 112 at the surface adjacent to the rear face 114.

With such a return roller 166, the mechanical action of the protrusions 168 makes it possible to return the slide valve elements 112 to the blocking position of FIG. 2a.

As an alternative to incorporating at least one protrusion 168, the shaft of the return roller 166 may be designed with stepped profiles that engage with one or more grooves 169 in the conveyor belt 102.

As further alternatives, the return of the slide valve elements 112 into the blocking position can be achieved by a compressed air blast from a compressed gas nozzle roughly indicated at 180 in FIG. 1 or by mechanical action by means of a return bar roughly indicated at 182 in FIG. 1.

It may also be considered to apply a preload to the slide valve element 112 in the direction of the blocking position. By means of this preload, a force is exerted on the slide valve element 112, which pushes it in the direction of the support surface 104, or the blocking position, which is shown in FIG. 2a. This preload can be provided, for example, by a spring arranged under the slide valve element 112, associated with the rear surface 114.

An alternative method for facilitating this procedure from the passage to the blocking position involves the use of magnets 184 and 186, as schematically illustrated in FIG. 2a. One magnet 186 from a pair of magnets is arranged in the conveyor belt 102 or, if present in the conveyor belt 102, in the valve insert 117 and the other magnet 184 from the pair of magnets is arranged in the slide valve element 112, so that the magnets from the pair of magnets can exert an attractive force on one another and can thereby pull the valve element 112 from the passage position into or at least in the direction of the blocking position.

Additionally or alternatively, magnets could also be arranged at the other end of the slide valve element 112, i.e. in the region of the projection 154. However, these magnets (not shown) would then have to be aligned in such a way that they repel each other in order to force the slide valve element 112 into its blocking position.

At least one magnet of the pair may advantageously be an active magnet, the other may be a passive magnet or a second active magnet.

FIGS. 4a to 4d show roughly schematically alternative courses 116a, 116b, 116c and 116d of the flow path, wherein in FIGS. 4a and 4b at 147a and 147b respectively the possibility is also indicated that the flow path opens into a depression in the support surface of the conveyor belt in order to increase the retaining force acting on the conveyed material.

FIGS. 5a, 5b and 6 to 10 feature various variants of a second embodiment of the invention, which differs from the first embodiment of FIGS. 1, 2a, 2b and 3 mainly in that the valve element is designed as a rocker. Therefore, in FIGS. 5a, 5b and 6 to 10, analogous parts are provided with the same reference numerals as in FIGS. 1, 2a, 2b and 3, however, increased by the number 100. The second embodiment will be described below only insofar as it differs from the first embodiment, to which reference is otherwise expressly made.

In the second embodiment, the rocker valve element 212 is mounted in a recess 220 which is formed in the support surface 204 of the conveyor belt 202.

Furthermore, the valve element 212 comprises an axle element 222 around which the valve element 212 is pivotable. This axle element 222 divides the valve element 212 into two sections 224, 226. One of the two designated sections is configured to close the flow path 216.

The axle element 222 may be formed integrally with the valve element, as can be seen from FIGS. 5a and 5b. The axle element can be mounted in a bearing 229 which is formed in the conveyor belt 202, preferably in the bottom of the recess 220.

It should be noted at this point that the bearing 229 can also be omitted.

Alternatively, the axle element 222 may comprise an elongated element 228 (see FIG. 6). This can be achieved, for example, by using a shaft—preferably made of metal—that is press-fitted through a through-bore in the conveyor belt 202 and the valve element 212.

The recess 220, in which the valve element 212 is mounted, may feature either a horizontal, flat base—as indicated by the dashed lines in FIG. 7 and shown in FIGS. 5a and 5b—or a stepped base, as depicted in FIG. 7.

To enable the valve element 212 to perform the pivoting movement required to transition between the blocking and passage positions, the valve element 212 may, particularly in the first case, include a stop surface 232. This stop surface interacts with a counter-stop surface 234 to limit the insertion movement of the section 224 into the recess 220 and thus to prevent the section 226 of the valve element 212 from protruding from the support surface 204 in a passage position and possibly lifting the conveyed material 210.

The counter-stop surface 234 may, as illustrated in FIG. 7, be formed by the base of the recess 220 or by a raised portion on or within it.

If the bottom of the recess 220 is stepped, this can prevent the valve element 212 from protruding from the support surface 204 in a passage position and possibly lifting the conveyed material 210.

The valve element 212 is arranged in the conveyor belt 202 to the extent that in the blocking position it protrudes at least partially from the support surface 204 of the conveyor belt 202, as can be seen from FIG. 5a. In the passage position according to FIG. 5b, however, the valve element 212 is arranged substantially flush with the support surface 204 or recessed therein.

In FIG. 5b, the valve element 212 is shown in the passage position, whereas the flow path 216 is unobstructed, establishing fluid communication between the suction box 208 and the support surface 204, so that negative pressure is applied to the conveyed material 210.

The blocking position is shown in FIG. 5a. In this position, no material 210 rests on the conveyor belt 202, and the flow path 216 is sealed by the valve element 212, preventing any or only minimal ingress of false air.

In this embodiment, the valve element 212 may also form part of a valve insert 217, which is integrated into a passage opening of the conveyor belt 202 (not shown in the figures for this embodiment).

In order to further improve the seal between the valve element in the blocking position and the flow path 216, as shown in FIG. 8, it may be considered to arrange a sealing lip 236 on the valve element 212 on the side facing the flow path 216, which sealing lip is designed and intended to cover the flow path 216. Such a sealing lip can, for example, be an elevation of the valve element of 0.5 mm. An example of this can be seen in FIG. 8.

As shown in FIG. 9, a valve element 212 designed as a rocker can also comprise a recess 238 in its side associated with the support surface 204 in order to increase the retaining force exerted on the conveyed material. Evacuation of the recess 238 is achieved through cutouts 242 located on the side opposite the support surface 204.

To ensure a secure and reliable closure of the suction line or flow path—particularly in scenarios where the conveyed material is prematurely removed from the conveyor belt or when no material is present—it may be advantageous to position the center of gravity of the valve element 212 within the section 226 of the valve element 212 that is designed to seal the flow path 216. This can be done, for example, by extending the section 226 or by enlarging the section 226. Furthermore, consideration may be given to manufacturing the section 226 from material which is denser than that of the section 224.

After the valve element 212 has passed over the deflection roller 206 and is once again positioned on the upper section of the conveyor path—prior to entering the segment above the suction box 208 (as exemplified in FIG. 1)—it tilts back into the blocking position solely under the influence of gravity, without the need for additional external forces. In order not to leave the return to the blocking position solely to gravity, it can also be considered that at the end of the deflection by the deflection roller 206 or a little after (in the conveying direction) a stop can extend across the conveyor belt 202, which gives the valve element 212 an impulse in the direction of the blocking position.

Such an effect can also be achieved by a compressed air blast from a compressed gas nozzle (not shown in the figures) onto the valve element 212 or by applying a preload to the valve element 212 in the direction towards the blocking position. To exert a preload force on the valve element 212, a mechanism can be implemented that applies pressure towards the flow path 216 and the blocking position, as depicted in FIG. 5b. One possibility for this may be a spring, which may be arranged, for example, on the section 226 of the valve element 212 on the side facing the flow path.

As discussed above, another option for assisting in moving from the passage position to the blocking position may involve the use of magnets.

To mitigate the elongation of the conveyor belt 202 on its outer side, incisions 272, 274 can be introduced into the conveyor belt 202, as illustrated in FIG. 10. This is advantageous as it allows the conveyor belt 202 to be constructed with increased height, i.e., greater thickness. These incisions can be positioned either on the support surface 204, as incision 272, or on the rear surface 214, as incision 274, as depicted in FIG. 10. Advantageously, the incisions 272, 274 are wedge-shaped. In conclusion, it should be noted that such incisions may also be incorporated into the initial embodiment, as illustrated in FIGS. 1, 2a, 2b, and 3.

1. Conveyor device, comprising:
a conveyor belt with a support surface and a rear surface facing away from the support surface;
at least one flow path connecting the support surface to the rear surface;
a suction box arranged on the rear surface of the conveyor belt and fluidly connected to one end of the flow path which opens into the rear surface; and
at least one valve element adjustable between a passage position and a blocking position,
wherein the valve element interrupts or closes the at least one flow path in its blocking position and establishes or releases it in its passage position,
and wherein the valve element in the blocking position protrudes at least partially from the support surface of the conveyor belt.

2. Conveyor device according to claim 1,
wherein the valve element is arranged in the passage position substantially flush with the support surface or countersunk therein.

3. Conveyor device according to claim 1,
wherein the at least one valve element is subjected to a preload in a direction towards the blocking position.

4. Conveyor device according to claim 1, further comprising at least one pair of magnets,
wherein one magnet from the pair of magnets is positioned within the conveyor belt or in a component connected to it, while the other magnet from the pair is embedded within the valve element,
wherein at least one of the pair of magnets is an active magnet, and
wherein the magnets are arranged and designed to exert either an attractive or repulsive force upon each other, thereby urging the valve element from the passage position towards the blocking position.

5. Conveyor device according to claim 1, further comprising at least one compressed gas nozzle which is designed and intended to move the at least one valve element from the passage position into the blocking position.

6. Conveyor device according to claim 1,
Wherein the valve element is part of a valve insert which is formed in a passage opening of the conveyor belt.

7. Conveyor device according to claim 1,
wherein the valve element is further assigned an axle element around which the valve element is pivotable and which divides the valve element essentially into two sections,
wherein one of these sections is designed and intended to close the flow path.

8. Conveyor device according to claim 7,
wherein the valve element has a stop surface which is designed and intended to interact with a counter-stop surface, and
wherein the stop surface and the counter-stop surface are designed and intended in cooperation to limit a movement of a portion which is not designed and intended to cover the flow path into a recess formed in the support surface.

9. Conveyor device according to claim 7,
wherein a sealing lip is arranged on the valve element on a side facing the flow path, which sealing lip is designed and intended to cover the flow path.

10. Conveyor device according to claim 7,
wherein the valve element has a cutout in a side facing the support surface, as well as at least one lateral cutout and/or at least one lateral cutout in the side facing away from the support surface.

11. Conveyor device according to claim 1,
wherein:
the valve element is a slide valve element which is displaceable between the passage position and the blocking position;
a section of the flow path extends in the slide valve element and one end of the section opens into a peripheral surface of the slide valve element; and
the flow path features at least one additional section, one end of which opens into one end of the one section of the flow path in the passage position of the slide valve element, while it is arranged offset relative to the latter in the blocking position.

12. Conveyor device according to claim 11,
wherein the slide valve element is arranged in the blocking position relative to the rear surface of the conveyor belt set back into a body of the conveyor belt.

13. Conveyor device according to claim 11,
further comprising a projection at the end of the slide valve element closest to the support surface with a stop surface and a counter-stop surface associated therewith, wherein the interaction of the stop surface and the counter-stop surface limits an insertion movement of the slide valve element into the support surface.

14. Conveyor device according to claim 11,
further comprising a projection at the end of the slide valve element closest to the rear surface with a stop surface and a counter-stop surface associated therewith, wherein the interaction of the stop surface and the counter-stop surface limits an insertion movement of the slide valve element into the rear surface.

15. Conveyor device according to claim 11,
further comprising a return roller with at least one protrusion which is designed and intended to displace the at least one slide valve element from the passage position into the blocking position.

16. Conveyor device according to claim 6,
wherein the flow path is formed in the valve insert.
